(19) United States
(12) Patent Application Publication
(10) Pub. No.: US 2018/0154537 A1
(43) Pub. Date: Jun. 7, 2018

(54) REMOTE CUTTING SYSTEM AND CONTROL METHOD OF CUTTING DEVICE

(71) Applicant: TECO IMAGE SYSTEMS CO., LTD., Taipei City (TW)

(72) Inventor: Ping-Tang Lu, Taipei City (TW)

(21) Appl. No.: 15/370,318

(22) Filed: Dec. 6, 2016

(51) Int. Cl. B26D 5/00; H04M 11/00; G05B 19/402

(52) U.S. Cl. CPC B26D 5/005; H04W 84/12; G05B 19/402; H04M 11/007

(57) ABSTRACT

A remote cutting system includes a cutting device and a control device. The cutting device includes a control unit, a wireless communication unit, a drive unit and a knife. The control device includes a processor, an accelerometer, a first button, a second button and a wireless connect unit. The accelerometer is connected with the processor for recording a move information. When the first button or the second button is pressed, a move command or a cutting command is generated according to the move information by the processor. A wireless connection is established between the wireless connect unit and the wireless communication unit for transmitting the move command or the cutting command, and then the drive unit is controlled by the control unit to drive the knife, so that the knife is driven to move or cut. Therefore, the manufacturing cost is reduced, and simultaneously the convenience is enhanced.

### FIELD OF THE INVENTION

The present invention relates to a remote cutting system, and more particularly to a remote cutting system and a control method of a cutting device.

### BACKGROUND OF THE INVENTION

Cutting devices utilizing the technologies of motor control and knife force control have become popular day by days. A designer, an artist or a normal user may use a drawing software installed in a computer to draw the graphics and use a cutting device to cut and output.

In addition, a cutting device is usually used for making stickers. There are two advantages. First of all, a user may avoid from touching the knife directly, so that the possibility of occurring an accident is reduced. Secondly, since the knife force control technology is utilized, the first layer of the paper of a sticker can be precisely cut, and the second layer of the paper of the sticker can keep away from being cut. In prior art, the manners of generating cutting patterns and cutting according to the cutting patterns can be classified as two types. The first type is that a user uses a drawing software installed in a computer to draw a cutting pattern and transmits the cutting pattern to a cutting device for cutting. The second type is that a user manually draws a cutting pattern on a paper and uses a cutting device for scanning and cutting.

The two types mentioned above have some drawbacks as following. To a user who is unfamiliar with using a drawing software, none of a cutting pattern can be finished by using a computer. The error values produced by the cutting pattern after scanning may cause cutting errors. Furthermore, setting a scanning module in the cutting device will increase the manufacturing cost, the price of product and the burden of the user.

Therefore, there is a need of providing an improved remote cutting system and an improved control method of a cutting device distinct from the prior art in order to solve the above drawbacks.

### SUMMARY OF THE INVENTION

Some embodiments of the present invention are to provide a remote cutting system and a control method of a cutting device in order to overcome at least one of the above-mentioned drawbacks encountered by the prior arts.

The present invention provides a remote cutting system and a control method of a cutting device. By utilizing an accelerometer of the control device for sensing and recording the move information of the control device, and pressing the first button and the second button for respectively moving or cutting according to the move information, it is not only unnecessary for a user to have skills in using drawing software, but also unnecessary to set a scanning module in the cutting device. Therefore, the manufacturing cost of the cutting device can be effectively reduced, and simultaneously the convenience is enhanced. The cutting operation corresponded to the locus of move, which is implemented by a manually control of a user, can be instantly performed.

The present invention also provides a remote cutting system and a control method of a cutting device. Since the first button corresponded to the moving operation and the second button corresponded to the cutting operation can be implemented by virtual buttons or substantial buttons, a user may install an application having a graphic first button and a graphic second button in a smart phone, or purchase a pen-shaped device having a substantial first button and a substantial second button to meet the practical demands. Therefore, the present invention can be widely applied, hence the user experiences are enhanced.

In accordance with an aspect of the present invention, there is provided a remote cutting system. The remote cutting system includes a cutting device and a control device. The cutting device includes a control unit, a wireless communication unit, a drive unit and a knife. The control device includes a processor, an accelerometer, a first button, a second button and a wireless connect unit. The wireless communication unit and the drive unit are connected with the control unit. The knife is connected with the drive unit. The accelerometer is connected with the processor for sensing and recording a move information of the control device. The first button, the second button and the wireless connect unit are connected with the processor. When the first button is pressed, a move command is generated according to the move information by the processor. When the second button is pressed, a cutting command is generated according to the move information by the processor. A wireless connection is established between the wireless connect unit and the wireless communication unit for transmitting the move command or the cutting command, and then the drive unit is controlled by the control unit to drive the knife, so that the knife is driven to move or cut.

In accordance with another aspect of the present invention, there is provided a control method of a cutting device. The control method includes steps of (a) providing a cutting device and a control device, (b) establishing a wireless connection between the cutting device and the control device, (c) judging whether to perform a cutting operation, (d) pressing a cutting button of the control device, (e) the control device obtaining a first move information through an accelerometer and transmitting the first move information to the cutting device, (f) the cutting device controlling a knife according to the first move information to move and simultaneously controlling the knife to perform the cutting operation, (g) judging whether to perform a moving operation, (h) pressing a move button of the control device, (i) the control device obtaining a second move information through the accelerometer and transmitting the second move information to the cutting device, (j) the cutting device controlling the knife according to the second move information to perform the moving operation, (k) judging whether to continuously perform another cutting operation or another moving operation, and (l) finishing the control. When the result of the judgement of the step (c) is True, the step (d), the step (e), the step (f) and the step (k) are performed after the step (c). When the result of the judgement of the step (c) is False, the step (g) is performed after the step (c). When the result of the judgement of the step (g) is True, the step (h), the step (i), the step (j) and the step (k) are performed after the step (g). When the result of the judgement of the step (g) is False, the step (l) is performed after the step (g). When the result of the judgement of the step (k) is True, the step (c) is re-performed after the step (k). When the result of the judgement of the step (k) is False, the step (l) is performed after the step (k).

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the configuration of a remote cutting system according to an embodiment of the present invention; and

FIG. 2 schematically illustrates the flow chart of a control method of a cutting device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

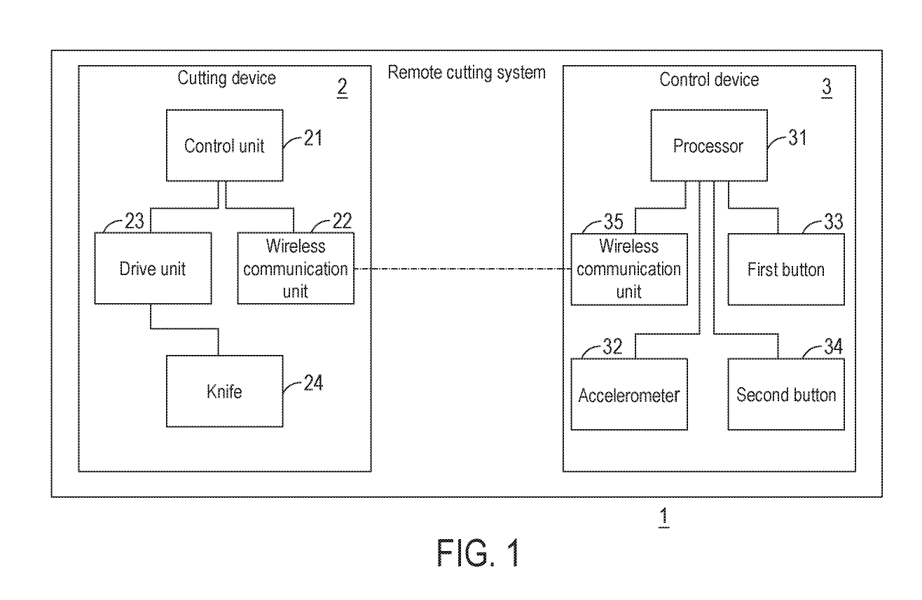

Please refer to FIG. 1. FIG. 1 schematically illustrates the configuration of a remote cutting system according to an embodiment of the present invention. As shown in FIG. 1, a remote cutting system 1 includes a cutting device 2 and a control device 3. The control device 2 includes a control unit 21, a wireless communication unit 22, a drive unit 23 and a knife 24. The control device 3 includes a processor 31, an accelerometer 32, a first button 33, a second button 34 and a wireless connect unit 35. The wireless communication unit 22 is connected with the control unit 21. The drive unit 23 is connected with the control unit 21, and the knife 24 is connected with the drive unit 23. In some embodiments, the control device is for example but not limited to a pen-shaped device (or called “cutting pen”) or a smart phone. The accelerometer 32 is connected with the processor 31 for sensing and recording a move information of the control device 3. The first button 33, the second button 34 and the wireless connect unit 35 are connected with the processor 31. When the first button 33 is pressed (e.g. by a user), a move command is generated according to the move information by the processor 31. When the second button 34 is pressed (e.g. by a user), a cutting command is generated according to the move information by the processor 31. A wireless connection is established between the wireless connect unit 35 and the wireless communication unit 22 for transmitting the move command or the cutting command, and then the drive unit 23 is controlled by the control unit 21 to drive the knife 24, so that the knife 24 is driven to move or cut.

By utilizing an accelerometer 32 of the control device 3 for sensing and recording the move information of the control device 3, and pressing the first button 33 and the second button 34 for respectively moving or cutting according to the move information, it is not only unnecessary for a user to have skills in using drawing software, but also unnecessary to set a scanning module in the cutting device. Therefore, the manufacturing cost of the cutting device 2 can be effectively reduced, and simultaneously the convenience is enhanced. The cutting operation corresponded to the locus of move, which is implemented by a manually control of a user, can be instantly performed.

In some embodiments, the first button 33 and the second button 34 of the control device 3 can be substantial buttons (i.e. physical buttons). For example, when the control device 3 of the present invention is a pen-shaped device, the first button 33 and the second button 34 are substantial buttons. In some embodiments, the first button 33 and the second button 34 of the control device 3 can be virtual buttons or graphic buttons. When an application having a graphic user interface (GUI) is installed in the control device 3, which is for example a smart phone, the first button 33 and the second button 34, which are graphic buttons, are the virtual buttons.

In addition, the first button 33 and the second button 34 of the control device 3 can be integrated as a single two-stage button. The first button 33 can be the first stage and the second button 34 can be the second stage, and vice versa.

In some embodiments, when a paper (not shown) is disposed on the cutting device 2 and the move command or the cutting command is received by the control unit 21, the drive unit 23 is simultaneously controlled by the control unit 21 to drive the paper.

The manners of establishing a wireless connection between the wireless communication unit 22 of the cutting device 2 and the wireless connect unit 35 of the control device 3 are illustrated as follows. The wireless connection is based on Wi-Fi or Bluetooth. The cutting device 2 can be designed to enable a wireless communication mode based on Wi-Fi or Bluetooth when the power of the cutting device 2 is turned on, and the control device 3 can be designed to match with the wireless communication mode when the power of the control device 3 is turned on, so that the wireless connection can be established.

In some embodiments, the cutting device 2 further includes a wireless communication button (not shown) connected with the control unit 21, and when the wireless communication button is pressed, a wireless communication mode based on Wi-Fi or Bluetooth is enabled by the wireless communication unit 22. The control device 3 further includes a wireless connect button (not shown) connected with the processor 31, and when the wireless connect button is pressed, the wireless connect unit 35 is matched with the wireless communication mode so as to establish the wireless connection.

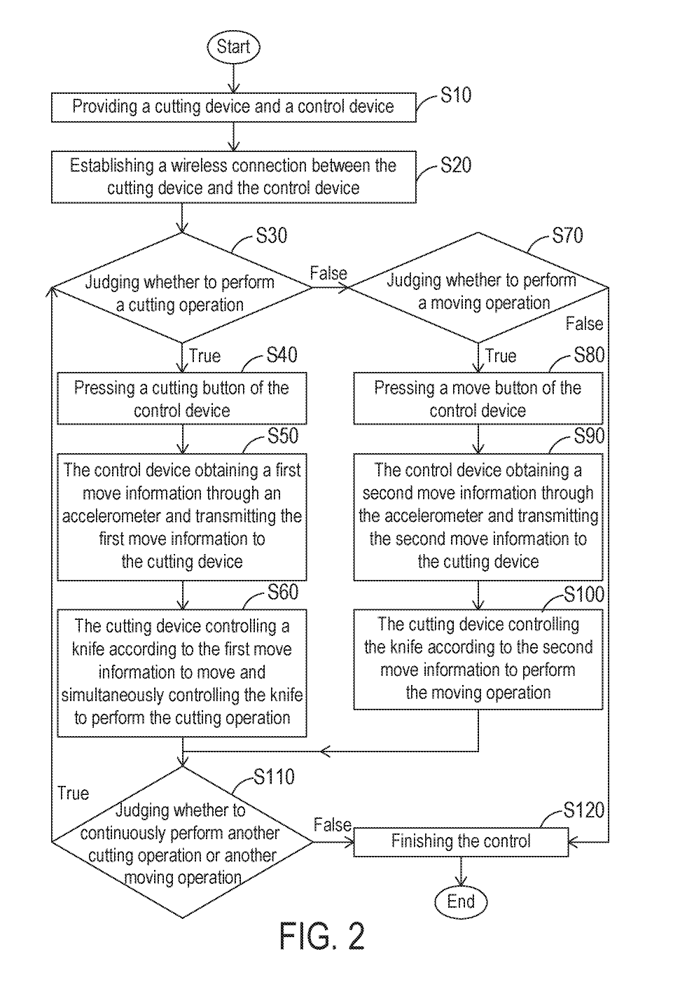

FIG. 2 schematically illustrates the flow chart of a control method of a cutting device according to an embodiment of the present invention. As shown in FIG. 1 and FIG. 2, a control method of a cutting device of the present invention includes steps as follows. First of all, as shown in step S10, providing a cutting device 2 and a control device 3. Next, as shown in step S20, establishing a wireless connection between the cutting device 2 and the control device 3. Then, as shown in step S30, judging whether to perform a cutting operation. When the result of the judgement of the step S30 is True, a step S40, a step S50, a step S60 and a step S110 are performed after the step S30. That is, when a user determines to perform a cutting operation, a step S40 of pressing a cutting button (i.e. the second button 34) of the control device 3 is firstly performed. Next, as shown in step S50, the control device 3 obtaining a first move information through an accelerometer 32 and transmitting the first move information to the cutting device 2. Then, as shown in step S60, the cutting device 2 controlling a knife 24 according to the first move information to move and simultaneously controlling the knife 24 to perform the cutting operation. The knife 24 is driven by a drive unit 23 as illustrated in the embodiments mentioned above, and is not redundantly described herein. Next, as shown in step S110, judging whether to continuously perform another cutting operation or another moving operation.

In some embodiments, when the result of the judgement of the step S30 is False, a step S70 of judging whether to perform a moving operation is performed after the step S30. When the result of the judgement of the step S70 is True, a step S80, a step S90, a step S100 and the step S110 are performed after the step S70. That is, when the user determines to perform a moving operation, a step S80 of pressing a move button (i.e. the first button 33) of the control device 3 is firstly performed. Next, as shown in step S90, the control device 3 obtaining a second move information through the accelerometer 32 and transmitting the second move information to the cutting device 2. Then, as shown in step S100, the cutting device 2 controlling the knife 24 according to the second move information to perform the moving operation. Next, as shown in step S110, judging whether to continuously perform another cutting operation or another moving operation.

When the result of the judgement of the step S70 is False, it represents that the user determines not to perform a cutting operation or a moving operation. In other words, the user wants to finish the control or end the flow chart of the control method of the present invention. Therefore, a step S120 of finishing the control is performed after the step S70 when the result of the judgement of the step S70 is False. Moreover, when the result of the judgement of the step S110 is True, which means that the user determines to continuously perform another cutting operation or another moving operation, the step S30 is re-performed after the step S110. When the result of the judgement of the step S110 is False, which means that the user determines not to continuously perform another cutting operation or another moving operation, the step S120 is performed after the step S110.

From the above description, the present invention provides a remote cutting system and a control method of a cutting device. By utilizing an accelerometer of the control device for sensing and recording the move information of the control device, and pressing the first button and the second button for respectively moving or cutting according to the move information, it is not only unnecessary for a user to have skills in using drawing software, but also unnecessary to set a scanning module in the cutting device. Therefore, the manufacturing cost of the cutting device can be effectively reduced, and simultaneously the convenience is enhanced. The cutting operation corresponded to the locus of move, which is implemented by a manually control of a user, can be instantly performed. Meanwhile, since the first button corresponded to the moving operation and the second button corresponded to the cutting operation can be implemented by virtual buttons or substantial buttons, a user may install an application having a graphic first button and a graphic second button in a smart phone, or purchase a pen-shaped device having a substantial first button and a substantial second button to meet the practical demands. Therefore, the present invention can be widely applied, hence the user experiences are enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A remote cutting system, comprising:
a cutting device, comprising:
a control unit;
a wireless communication unit connected with the control unit;
a drive unit connected with the control unit; and
a knife connected with the drive unit; and
a control device, comprising:
a processor;
an accelerometer connected with the processor for sensing and recording a move information of the control device;
a first button connected with the processor, wherein when the first button is pressed, a move command is generated according to the move information by the processor;
a second button connected with the processor, wherein when the second button is pressed, a cutting command is generated according to the move information by the processor; and
a wireless connect unit connected with the processor, wherein a wireless connection is established between the wireless connect unit and the wireless communication unit for transmitting the move command or the cutting command from the wireless connect unit to the wireless communication unit, and then the drive unit is controlled by the control unit to drive the knife, so that the knife is driven to move or cut.

2. The remote cutting system according to claim 1, wherein the first button and the second button are virtual buttons.

3. The remote cutting system according to claim 1, wherein the first button and the second button are integrated as a single two-stage button.

4. The remote cutting system according to claim 1, wherein when a paper is disposed on the cutting device and the move command or the cutting command is received by the control unit, the drive unit is simultaneously controlled by the control unit to drive the paper.

5. The remote cutting system according to claim 1, wherein the control device is a pen-shaped device.

6. The remote cutting system according to claim 1, wherein the control device is a smart phone.

7. The remote cutting system according to claim 1, wherein the wireless connection is based on Wi-Fi or Bluetooth.

8. The remote cutting system according to claim 7, wherein the cutting device further comprises a wireless communication button connected with the control unit, and when the wireless communication button is pressed, a wireless communication mode based on Wi-Fi or Bluetooth is enabled by the wireless communication unit.

9. The remote cutting system according to claim 8, wherein the control device further comprises a wireless connect button connected with the processor, and when the wireless connect button is pressed, the wireless connect unit is matched with the wireless communication mode so as to establish the wireless connection.

10. A control method of a cutting device, comprising steps of:
(a) providing a cutting device and a control device;
(b) establishing a wireless connection between the cutting device and the control device;
(c) judging whether to perform a cutting operation;
(d) pressing a cutting button of the control device;
(e) the control device obtaining a first move information through an accelerometer and transmitting the first move information to the cutting device;
(f) the cutting device controlling a knife according to the first move information to move and simultaneously controlling the knife to perform the cutting operation;
(g) judging whether to perform a moving operation;
(h) pressing a move button of the control device;
(i) the control device obtaining a second move information through the accelerometer and transmitting the second move information to the cutting device;
(j) the cutting device controlling the knife according to the second move information to perform the moving operation;
(k) judging whether to continuously perform another cutting operation or another moving operation; and
(l) finishing the control,
wherein when the result of the judgement of the step (c) is True, the step (d), the step (e), the step (f) and the step (k) are performed after the step (c), when the result of the judgement of the step (c) is False, the step (g) is performed after the step (c), when the result of the judgement of the step (g) is True, the step (h), the step (i), the step (j) and the step (k) are performed after the step (g), when the result of the judgement of the step (g) is False, the step (l) is performed after the step (g), when the result of the judgement of the step (k) is True, the step (c) is re-performed after the step (k), and when the result of the judgement of the step (k) is False, the step (l) is performed after the step (k).
